(19) United States
(12) Patent Application Publication
(10) Pub. No.: US 2008/0131113 A1
(43) Pub. Date: Jun. 5, 2008

(54) CAMERA HOUSING WITH A VIEW LENS, METHOD FOR MAKING THE CAMERA HOUSING, AND CAMERA USING THE HOUSING

(75) Inventor: Chia-Hsin Chang, Jen Te (TW)

Correspondence Address: PCE INDUSTRY, INC.;ATT. CHENG-JU CHIANG, 458 E. LAMBERT ROAD, FULLERTON, CA, 92835, US

(73) Assignee: CHI MEI COMMUNICATION SYSTEMS, INC., Jen Te (TW)

(21) Appl. No.: 11/690,031

(22) Filed: Mar. 22, 2007

(30) Foreign Application Priority Data
Dec. 1, 2006 (CN) 200610157303.X

(51) Int. Cl. G03B 17/00

(52) U.S. Cl. 396/529; 396/535

(57) ABSTRACT

A housing (100), used, e.g., in an electronic device, receives an optical system (30) therein. The housing includes a housing body (10) and a view lens (20). The housing body defines a view opening (112) corresponding to the optical system. The view lens is received in the view opening and is alignable along an optical axis direction of the optical system to allow light entering into the optical system. The housing body is moldingly attached with the view lens.

### CROSS-REFERENCE TO RELATED APPLICATIONS

This application is related to a co-pending U.S. patent application Ser. No. 11/551,675 (Attorney Docket No. US8846), entitled “COVER FOR A MOBILE DEVICE”, by Chang-Qing Yang et al. That application has the same assignee as the present application and has been filed on Oct. 20, 2006. The above-identified application is incorporated herein by reference.

### BACKGROUND OF THE INVENTION

1. Field of the Invention

The present invention relates to mobile-device camera housings and, particularly, to a camera housing with a view lens, and to a method for making the housing.

2. Description of Related Art

Nowadays, many electronic devices, such as mobile phones, have any of a variety of camera modules mounted therein so as to enable them to take pictures. A camera module used in an electronic device is typically received in a housing. The housing has a view lens, which functions as a view panel allowing light to enter into the camera module and which also functions as a protective member, preventing the camera module being damaged or soiled.

Referring to FIG. 1, a conventional housing 90 with a view lens includes a housing portion 91 and a view lens 92. The housing portion 91 and the view lens 92 are, respectively, manufactured by two separate molding processes. The view lens 92 has a rim portion 93, which adheres to the housing portion 91 via an adhesive layer 94. However, the view lens of the housing 90 in FIG. 1 may easily become detached from the housing body 91 during use, as the effectiveness of the adhesive layer 94 can decrease with time. As a result of even partial detachment, moisture and dust in the ambient air can enter into the optical module, thus potentially damaging to the optical module. Of course, complete detachment would create even a greater concern. Furthermore, the housing portion 91 and the view lens 92 are made by two separate processes, which would require additional time to properly adhere the view lens 92 to the housing portion 91 and which would prolong the time needed to produce the housing 90, as well.

Therefore, a camera housing with a view lens is desired in order to overcome the above-described shortcomings.

### SUMMARY OF THE INVENTION

In one embodiment thereof, a camera housing is provided. The camera housing is used in a camera in which an optical system received therein. The camera housing includes a housing body and a view lens. The housing body defines a view opening capable of being positioned in optical alignment with the optical system. The view lens is received in the view opening and is alignable along an optical axis direction of the optical system to allow light to enter into the optical system. The view lens is moldingly attached with the housing body.

Other advantages and novel features will become more apparent from the following detailed description of preferred embodiments when taken in conjunction with the accompanying drawings.

### BRIEF DESCRIPTION OF THE DRAWINGS

Many aspects of the camera housing with a view lens can be better understood with reference to the following drawing. The components in the drawing are not necessarily drawn to scale, the emphasis instead being placed upon clearly illustrating the principles of the housing with a view lens. Moreover, in the drawing like reference numerals designate corresponding parts throughout the several views.

FIG. 1 is a cross-sectional view of a conventional housing;

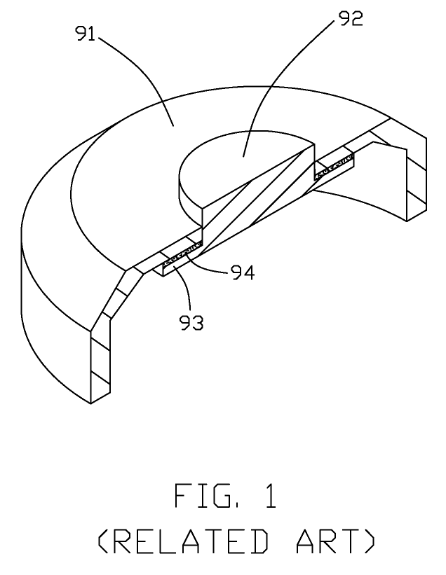

FIG. 2 is a perspective view of a preferred embodiment of a housing for a camera;

FIG. 3 is a cross-sectional view of the housing, taken along line III-III in FIG. 2;

FIG. 4 is an exploded, cross-sectional view of the camera housing, as shown in FIG. 3;

FIG. 5 is a cross-sectional view of another embodiment of a housing for a camera; and

FIG. 6 is a cross-sectional view of the camera housing, as shown in FIG. 3, with an optical module received therein;

FIG. 7 is a schematic view of a mold for making the camera housing in FIG. 2; and

FIG. 8 is a schematic view of the mold in FIG. 7, with the camera housing molded therein.

### DETAILED DESCRIPTION OF THE INVENTION

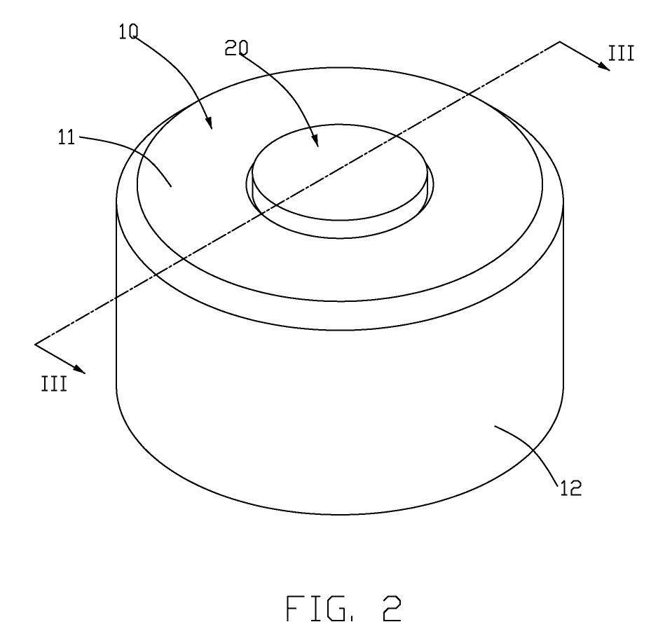

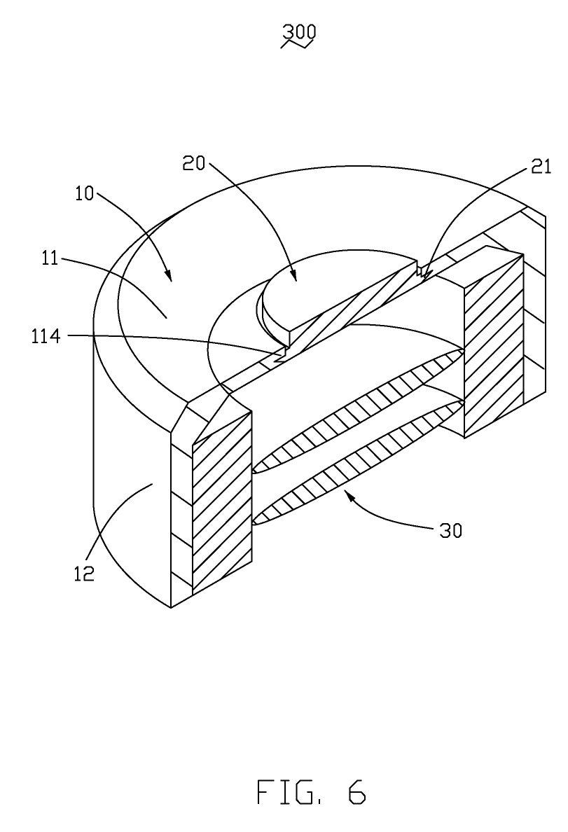

Referring to FIG. 2, in a preferred embodiment, a housing 100 for a camera (e.g., shown in FIG. 6), e.g., of a portable electronic device, includes a housing body 10 and a view lens 20. The view lens 20 is received in the housing body 10.

The housing body 10 is preferably made of a plastic material. The plastic material can, e.g., be chosen from the group including polyvinyl chloride, polyethylene terephthalate, acrylonitrile-butadiene-styrene, polycarbonate, polyimide, liquid crystal polymer, polyetherimide, polyphenylene sulfide, polysulfone, polystyrene, glycol-modified polyester, polypropylene, and any desired combination thereof.

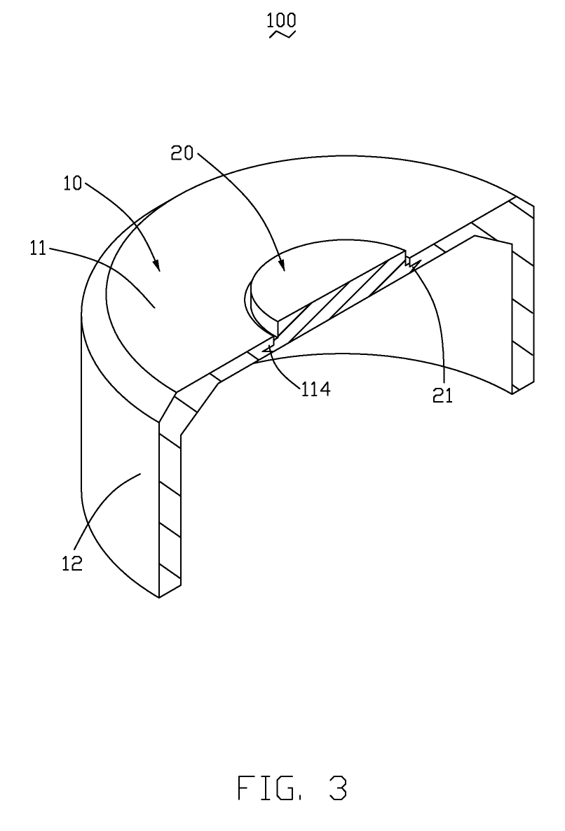

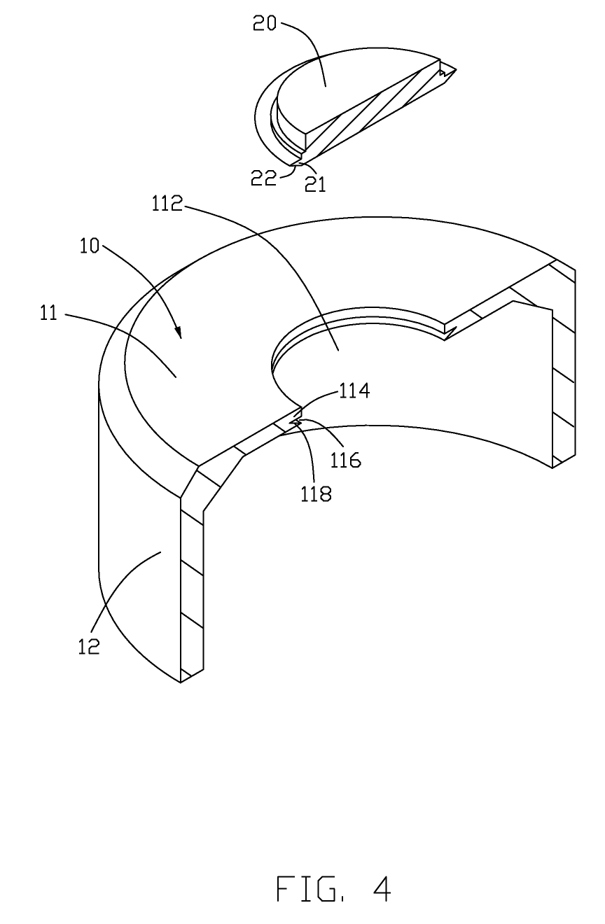

Referring to FIG. 3 and FIG. 4, the housing body 10 includes a plate portion 11 and a sleeve portion 12. The plate portion 111 has a circular view opening 112 and an inner rim 114 defining the circular view opening 112. The inner rim 114 has an annular groove 116 formed therein. The groove 116 of the inner rim 114 is defined, in part, by an annular slanted groove wall 118. The sleeve portion 12 has a receiving space formed therein that is configured (i.e., structured and arranged) for accommodating an optical element. The plate portion 11 is formed (either integrally or attached) on one distal end of the sleeve portion 12.

The view lens 20 is made of an optical plastic material, advantageously chosen from the group including polycarbonate, polymethyl methacrylate, polystyrene, and any desired combination thereof. The view lens 20, beneficially, has a surface with a scratch-resistant, anti-reflection coating made of SiO2 or Al2O3 applied thereon (e.g., applied directly thereto). Thus, a surface hardness of the view lens 20 can reach to 5H, and a transmittance of the view lens 20 can reach to 99%. It should be understood, of course, that the view lens could also instead be made of glass. It is desirable for the view lens 20 to be durable (mechanically and, to at least some degree, chemically) and scratch-resistant, so as to protect the interior portions of the camera with which it is associated and to not compromise the photo-taking abilities thereof.

The view lens 20 is circular disc-shaped and has a stepped ringed outer rim 21, projecting from an annular flange thereof. The stepped ringed outer rim 21 has a slanted sidewall 22. It is understood that the view lens 20 may be of another shape, such as rectangular.

The housing body 10 is, advantageously, injection moldingly attached with the view lens 20, with the view lens 20 being received into the circular view opening 112. The outer rim 21 of the view lens 20 is thereby engaged in the groove 116 of the inner rim 114, with the slanted sidewall 22 resisting the slanted groove wall 118. Thus, the view lens 20 is locked in the circular view opening 112 via the engagement of the outer rim 21 of the view lens 20 and the inner rim 114 of the housing body 10. The injection molding insures an interference fit between outer portion (i.e., the outer rim 21 and the slanted sidewall 22) of the view lens 20 and the circular view opening 112 of the housing body 10. It is to be understood that the compatibility of the materials used for the housing body 10 and the view lens 20 could effectively create a plastic weld between such elements, as well.

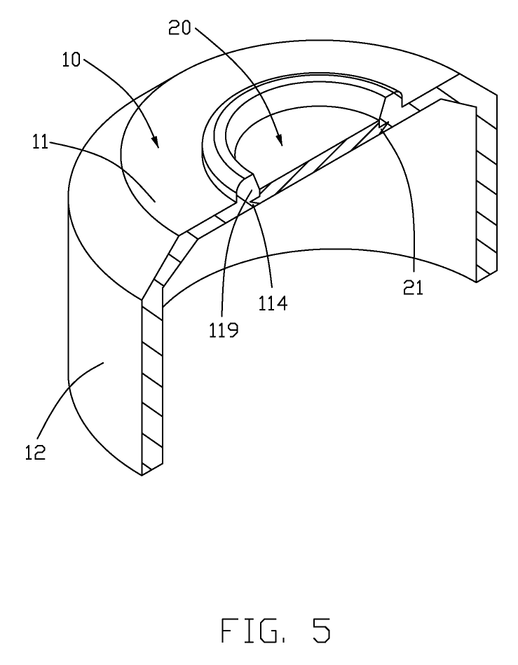

It should be understood, referring to FIG. 5, that the inner rim 114 can also have a decorative ring 119 formed thereon and extending therefrom. The view lens 20 can be recessed relative to the decorative ring 119, so as to reduce the opportunity for abrasion of the view lens 20. That is, the decorative ring 119, by projecting forward of the view lens 20, can likely absorb some impacts that might otherwise impinge upon the view lens 20.

Referring to FIG. 6, the housing 100 can be used in an electronic device, such as a camera 300 with an optical system 30 received therein. The camera 300 includes the housing 100 and the optical system 30. The optical system 30 is received in and carried by the sleeve portion 12 of the housing 100. The view lens 20 is alignable along an optical axis of the optical system 30 to allow light to enter into the optical system 30. It is understood that the present housing 100 may also be used in another electronic devices with optical systems other than digital cameras, per se, such as image pick-up systems used in cars, infrared optical systems, projection optical systems, and real-time detector systems.

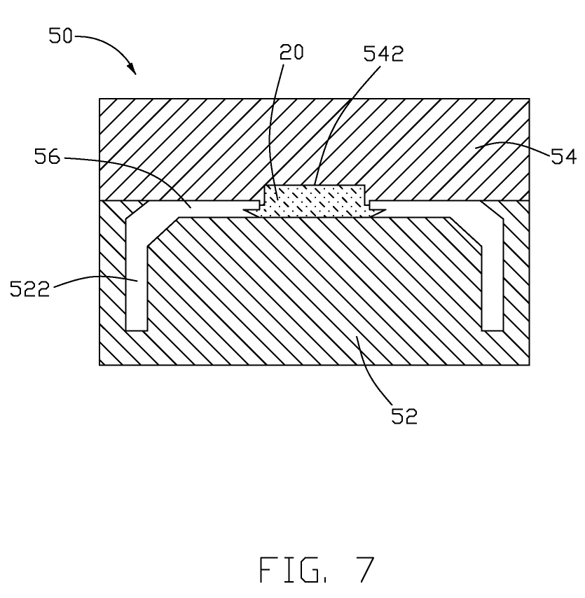

An exemplary method for making the housing 100 is provided. Firstly, the view lens 20 is provided. The view lens 20 can, advantageously, be formed by injection molding and is made of an optical plastic material. Secondly, an anti-reflection coating (e.g., SiO2 or Al2O3) is applied onto a surface of the view lens 20. Thirdly, referring to FIG. 7, the view lens 20 is inserted into a mold 50. The mold 50 includes a female mold 52 and a male mold 54 engaging with the female mold 52. The female mold 52 has an annular cavity 522 defined therein. The male mold 54 has a molding core 542 mounted therein. The view lens 20 is fixed in the molding core 542.

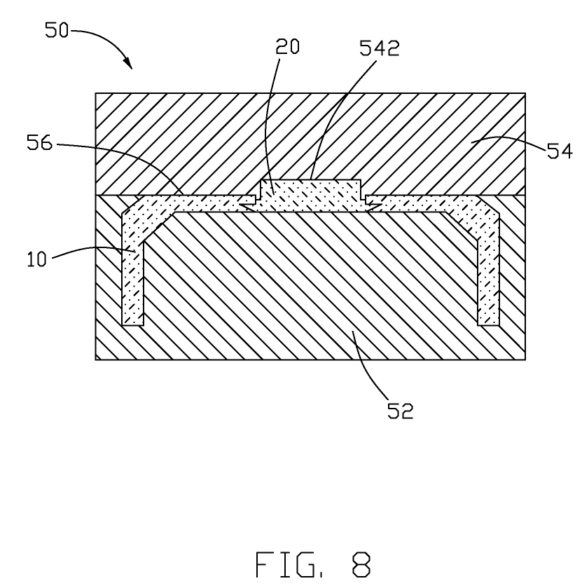

Fourthly, the mold 50 is closed, and thus a molding cavity 56 including the annular cavity 522 is defined between the female mold 52 and the male mold 54. Fifthly, referring to FIG. 8, a melted plastic is injected into the molding cavity 56. Thus, the housing body 10 is moldingly attached with the view lens 20 in the molding cavity 56 by injection molding. The housing body 10 is preferably made of a plastic material, as provided above.

It should be understood that the view lens 20 could be fixed to the housing body 10 by injection molding, effectively creating an interference fit and, most likely, a plastic weld therebetween. Thus, in the process of making the housing 100, there is no need to fix the view lens 20 to the housing body 10 using an additional glue or other adhesive. The view lens 20 and the housing body 10 can be joined together with no gap and with a concordant seal. As such, the cover can obtain a desired level of airproof, water-resistant, and dustproof performance.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A camera housing configured for receiving an optical system therein, the camera housing comprising:
a housing body defining a view opening capable of being positioned in optical alignment with the optical system;
a view lens received in the view opening and alignable along an optical axis direction of the optical system to allow light to enter into the optical system, the housing body being moldingly attached with the view lens.

2. The camera housing as claimed in claim 1, wherein the housing body includes a plate portion and a sleeve portion, the plate portion being formed on one end of the sleeve portion, the optical system being receivable in the sleeve portion.

3. The camera housing as claimed in claim 2, wherein the plate portion has an inner rim defining the view opening, the inner rim having an annular groove formed therein, the view lens having a ringed outer rim projecting from an annular flange of the view lens, the outer rim of the view lens being engaged in the groove of the plate portion.

4. The camera housing as claimed in claim 3, wherein the annular groove of the inner rim includes a slanted groove wall, the ringed outer rim having a slanted sidewall, and the slanted sidewall resisting the slanted groove wall.

5. The camera housing as claimed in claim 3, wherein the inner rim has a decorative ring formed thereon, the view lens being recessed relative to the decorative ring.

6. The camera housing as claimed in claim 1, wherein the view lens has a surface with a scratch-resistant, anti-reflection coating applied thereon.

7. The camera housing as claimed in claim 1, wherein the housing body is made of a plastic material.

8. The camera housing as claimed in claim 1, wherein the view lens is made of an optical plastic material.

9. The camera housing as claimed in claim 1, wherein the view lens is disc-shaped.

10. A method for making a camera housing with a view lens, comprising the steps of:
providing a view lens;
inserting the view lens into a mold, with a mold cavity defined in the mold;
injecting a melted plastic into the mold cavity to form a housing body, with the housing body being moldingly attached with the view lens.

11. The method as claimed in claim 10, wherein the housing body includes a plate portion and a sleeve portion, the plate portion being formed on one end of the sleeve portion.

12. The method as claimed in claim 11, wherein the view lens has a ringed outer rim projecting from an annular flange of the view lens, the plate portion of the housing body having an inner rim defining a view opening, the inner rim having a groove formed therein, the outer rim of the view lens engaging in the groove of the plate portion.

13. The method as claimed in claim 12, wherein the ringed outer rim of the view lens has a slanted sidewall, the inner rim having a slanted groove wall, and the slanted sidewall resisting the grooved wall.

14. The method as claimed in claim 10, further comprises a step of applying a scratch-resistant, anti-reflection coating onto a surface of the view lens.

15. A camera, comprising:
an optical system; and
a housing receiving the optical system therein, the housing comprising:
a housing body carrying the optical system, the housing body further defining a view opening, the view opening being positioned in optical alignment with the optical system; and
a view lens received in the view opening, the view lens being aligned along an optical axis direction of the optical system to allow light to enter into the optical system, the housing body being moldingly attached with the view lens.

16. The camera as claimed in claim 15, wherein the housing body includes a plate portion and a sleeve portion, the plate portion being formed on one end of the sleeve portion, the optical system being receivable in the sleeve portion.

17. The camera as claimed in claim 16, wherein the plate portion has an inner rim defining the view opening, the inner rim having an annular groove formed therein, the view lens having a ringed outer rim projecting from an annular flange of the view lens, the outer rim of the view lens being engaged in the groove of the plate portion.

18. The camera as claimed in claim 17, wherein the annular groove of the inner rim includes a slanted groove wall, the ringed outer rim having a slanted sidewall, and the slanted sidewall resisting the slanted groove wall.
